(19) United States
(12) Patent Application Publication
(10) Pub. No.: US 2019/0156438 A1
(43) Pub. Date: May 23, 2019

(54) ENERGY AND PRODUCTION OPTIMIZATION SYSTEM FOR FACTORY TO GRID INTEGRATION

(71) Applicant: Siemens Aktiengesellschaft, Munich (DE)

(72) Inventors: Zhen Song, Plainsboro, NJ (US); Thomas Gruenewald, Somerset, NJ (US); George Lo, Langhorne, PA (US)

(21) Appl. No.: 15/772,659

(22) PCT Filed: Nov. 11, 2016
(86) PCT No.: PCT/US2016/061571

§ 371 Date: May 1, 2018

Related U.S. Application Data
(60) Provisional application No. 62/254,917, filed on Nov. 13, 2015.

(51) Int. Cl. G06Q 50/06; G05B 13/04; G06Q 10/06; G06Q 30/02; H02J 13/00

(52) U.S. Cl. CPC G06Q 50/06; G05B 13/047; H02J 13/0006; G06Q 30/0202; G06Q 30/0206; G06Q 10/06312

(57) ABSTRACT

Production tasks are scheduled to optimize production constraints while taking time varying energy prices into account. An energy management layer (EML) is in communication with a manufacturing domain as well as a smart grid domain. The EML receives information relating to a factory workflow, costs associated with operating units within the factory, and static utility information such as tariff models and incentives. Time variant energy price information is obtained from a utility regarding periodic price levels for a near future timeframe. The workflow is converted to a matrix representation that is acceptable to a mixed integer linear programming (MILP) solver. An algebraic factor representing a tradeoff between energy cost and full-capacity production is minimized to produce production variables which control production and limit production units and tasks to be performed during time slots that are most economically favorable.

### TECHNICAL FIELD

This application relates to factory prod uction. More particularly, this application relates to factory production scheduling and energy requirements.

### BACKGROUND

Production scheduling in a Manufacturing Execution System (MES) does not address future energy management, particularly with respect to aspects of Smart Grid technologies including variable energy pricing in future Smart Grids. Scheduling optimization functions in discrete manufacturing industries are designed to maximize production only, without consideration of time varying energy prices (including energy tariffs, demand charge, demand response, tax incentives, and the like) in the optimization process. Presently, manufacturing process optimizations are separated from the energy management system. They are not integrated, and as a result cannot coordinate the relationship between production and energy tariff. Systems and methods that overcome these shortcomings in the art are desired.

### SUMMARY

In this disclosure, an Energy tariff and Production integrated optimization software, namely, Energy Management Layer (EML) is described. EML is physically deployed inside a factory plant, with access to the MES layer. Meanwhile, EML also communicates with utility-side demand management systems, such as Energy Price Servers, via Internet protocols including but not limited to OpenADR. A key role for EML is incorporating factories into the Smart Grid, by optimizing production schedules according to the Smart Grid conditions.

Manufacturing energy management is aligned with future energy management goals and well suited for future technologies such as the digital factory.

A method for optimizing production operations with respect to energy delivery costs in a factory includes establishing an energy management layer in communication with an energy domain containing a smart grid and a manufacturing domain containing a manufacturing execution system. Information relating to the operation of production units (e.g. machines) is provided to the energy management layer. Further, information relating to time varying energy prices is provided to the energy management layer. The energy management layer optimizes a production schedule for the performance of at least one task by at least one production unit. The production schedule occurs during a time window optimized at least in part by the time varying energy price information.

According to an embodiment the energy management layer is provided information relating to the operation of production units including information relating to a workflow of the factory, information relating to the cost of operation of at least one of the production units, and information relating to a tariff model and/or incentives provided by a utility.

According to another embodiment, time varying energy price information includes a periodic schedule of energy prices from a utility reflecting a unit cost of energy for a pre-determined time period in a near future timeframe. The periodic schedule of energy prices may be obtained from a public data store of the utility. In an embodiment, the periodic schedule of energy prices lists energy prices on an hourly basis for a day following the day on which the periodic schedule of energy prices was retrieved from the public data store.

According to one embodiment, the workflow of the factory may be represented in a State-Task Network. In another embodiment, the workflow of the factory may be represented in a Resource-Task Network.

According to an embodiment, the energy management layer is in communication with the energy domain containing the smart grid through a distributed network. In one embodiment, the distributed network is the Internet.

In an embodiment, optimizing the production schedule for the factory includes determining a power quote for each time slot of a plurality of time slots within a given timeframe, determining energy costs for each of the time slots, and scheduling at least one task in time slots which have been determined to have a minimized energy cost while meeting the power quote constraint for the scheduled time slots.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagrammatic illustration of a smart energy grid according to embodiments of the disclosure.

FIG. 2a is a block diagram of an energy management layer connecting a manufacturing domain and a smart grid domain according to embodiments of this disclosure.

FIG. 2b is a block diagram of the energy management layer of FIG. 2a showing the energy management layer in greater detail according to embodiments of this disclosure.

FIG. 3 is an exemplary state task network diagram according to embodiments of this disclosure.

FIG. 4 is an exemplary resource task network diagram according to embodiments of this disclosure.

FIG. 5 is a block diagram showing the operation of an energy management software layer according to embodiments of this disclosure.

FIG. 6 is an illustration of a manufacturing time line across multiple machines optimized to time-based energy costs according to an embodiment of this disclosure.

FIG. 7 is a block diagram of a computer configured as a special purpose machine for performing optimization of manufacturing operations based on energy costs according to one embodiment of this disclosure.

FIG. 8 is a process flow diagram of a method to optimize a factory workflow based at least in part on time-varying energy prices according to embodiments of this disclosure.

### DETAILED DESCRIPTION

Today's production scheduling function as part of a Manufacturing Execution System (MES) does not address future energy management requirements in the age of the Smart Grid. The scheduling optimization functions in discrete manufacturing industries are designed to maximize production only, without consideration of time varying energy prices (including energy tariff, demand response, tax incentives) in the optimization process.

Energy prices change significantly over time due to a number of factors. For one, as renewable energy sources become more prevalent and are connected to the power grid, the power that is produced from renewable sources is often varying. For example, a wind farm having a number of wind turbines may be connected to the power grid. Depending on weather and wind conditions, the wind farm may provide significant electrical power to the grid on days when there is a prevailing wind sufficient to turn the turbines and generate electricity. Similarly, solar panels having photo voltaic (PV) cells may also be connected to the power grid. PV cells are subject to reduced power generation due to atmospheric conditions. For example, when the PV cells do not have adequate access to sunlight, their ability to generate electrical power is reduced or eliminated. Accordingly, during dark hours, or on days when clouds occlude the PV cells, the provision of electrical power from PV sources may be adversely affected. As a result, utility companies may change the price of electricity hourly throughout the day due to supply, meaning that at certain times of day, energy may be obtained at a lower price when supply is good than at other times of day when the supply may be limited. A facility or factory that can shift or shave its energy usage from periods of high demand to times of lower demand may experience significant economic benefits.

In addition, as technology and industry progress, the need for power increases. Whether energy is used for powering heating, ventilation, air conditioning (HVAC) systems to maintain comfort levels for building occupants, or for providing electric power to industrial machinery, as technology progresses, the demand for power increases. There may be times within a given day when power demand is greater than other times of the day. One solution to limited energy supply is to expand power generation facilities such as nuclear or coal plants. Furthermore, backup generators that run on diesel fuel may be used to temporarily power a building or factory during times of restricted energy supplies. However, environmental concerns including the safety of nuclear power and the environmental impact of coal-burning plants create impediments to new construction of these plants. Notwithstanding these impediments to new plant construction, diesel backup generators are expensive to implement and the costs to implement diesel generators to support power grid supplies wind up not being cost effective. Thus, when demand cannot be met, utilities may increase the price of available energy or alternatively, may need to restrict power to some parts of the grid. Nevertheless, total energy demand continues to grow. Furthermore, it is generally believed that there are strong correlations between gross domestic product (GDP) growth and electric usage. It is predictable that the energy demand from major economic entities will continue to grow.

As a result, utilities use incentives (and tariff models) to encourage peak demand shaving and shifting. For example, according to the Small Commercial (SC) 9 tariff model, New York State may charge up to $50 per kW-month for the peak demand of the month. Thus, 15 minutes of uncontrolled demand during peak hours may result in unacceptable energy bills for the month which may result in potential pecuniary losses. Accordingly, manufacturers cannot ignore the impact of time varying energy prices into the future.

Conventional manufacturing process optimizations are segregated from energy management systems. These systems are not integrated, and cannot coordinate relationships between production and energy. Manufacturing process optimizations operate on the premise of optimizing the schedule to maximize production. On the other hand, systems such as Real-time Pricing Servers (RTPS), manage peak load for utilities. These systems generally work at the sub-station level or higher.

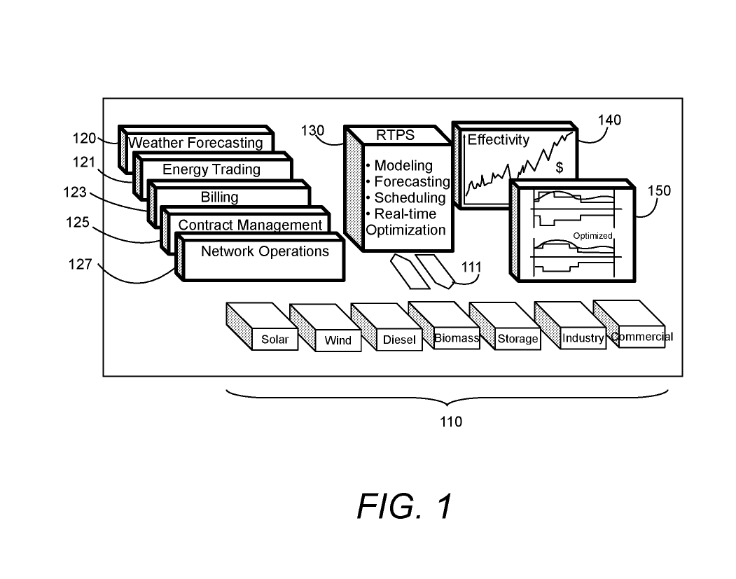

FIG. 1 is a block diagram of a RTPS system for managing loads in a smart grid. Energy sources 110, including solar, wind, backup diesel generators, biomass, energy storage (e.g. battery), and users of energy including industry and commercial buildings place energy into and take energy from 111 the smart grid. An RTPS 130 may receive information from the smart grid sources 110 and perform modeling, forecasting, scheduling and real-time optimization. Based on demand response, the RTPS may provide a utility with information on how to best distribute power loads across system resources, including sub-stations, feeder lines, areas (e.g. zip codes) and other associations. In this way the RTPS allows the utility to condition the load so that grid conditions are favorable to safe and reliable operations. The RTPS 130 receives information from external sources such as weather forecasting 120, energy trading information 121, billing information 123, contract management 125 and network operations 127. The RTPS 130 uses the external sources along with the smart grid sources 110 to determine effectiveness information 140 and to optimize power distribution load 150 to provide reliable operation.

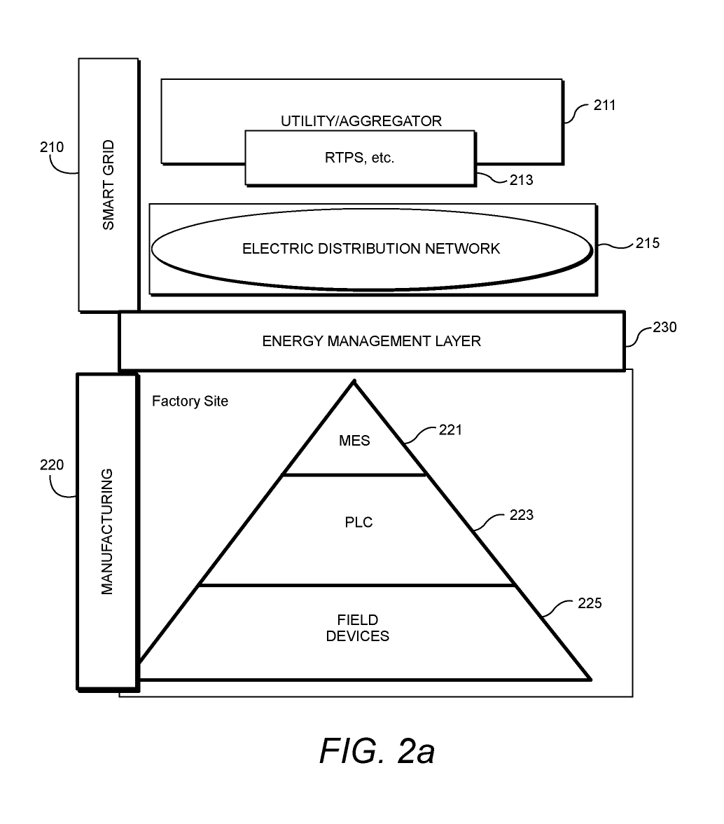

Referring now to FIG. 2a, a block diagram of an energy management layer 230 connecting a smart grid domain 210 and a manufacturing production domain 220 is shown. The smart grid domain 210 includes a utility, independent system operator (ISO), aggregator 211 who manages the electrical power grid including energy sources and users as described above with regard to FIG. 1. A demand response management system or similar functionality 213 is in communication with the utility/aggregator 211 and manages external sources and energy sources and users to allow utilities 211 to condition the electrical power grid based on demand response. An electrical distribution network 215 provides the infrastructure for transferring power from the smart grid to users. In addition pricing, tariff models and contractual factors may be implemented and ultimately affect the electric distribution network 215.

Manufacturing domain 220 includes the factory site which defines the automation pyramid comprising the MES 221 which controls the machines and task completion in the factory. The MES 221 provides control signals which are provided to programmable logic controllers (PLCs) 223. PLCs 223 provide control signals to actuators associated with field devices 225. The control signals are operable to cause the field devices 225 to operate according to parameters determined by the MES 221.

Energy management layer (EML) 230 provides communication between the smart grid domain 210 and the manufacturing domain 220. Energy management layer 230 utilizes Energy and Production integrated optimization software.

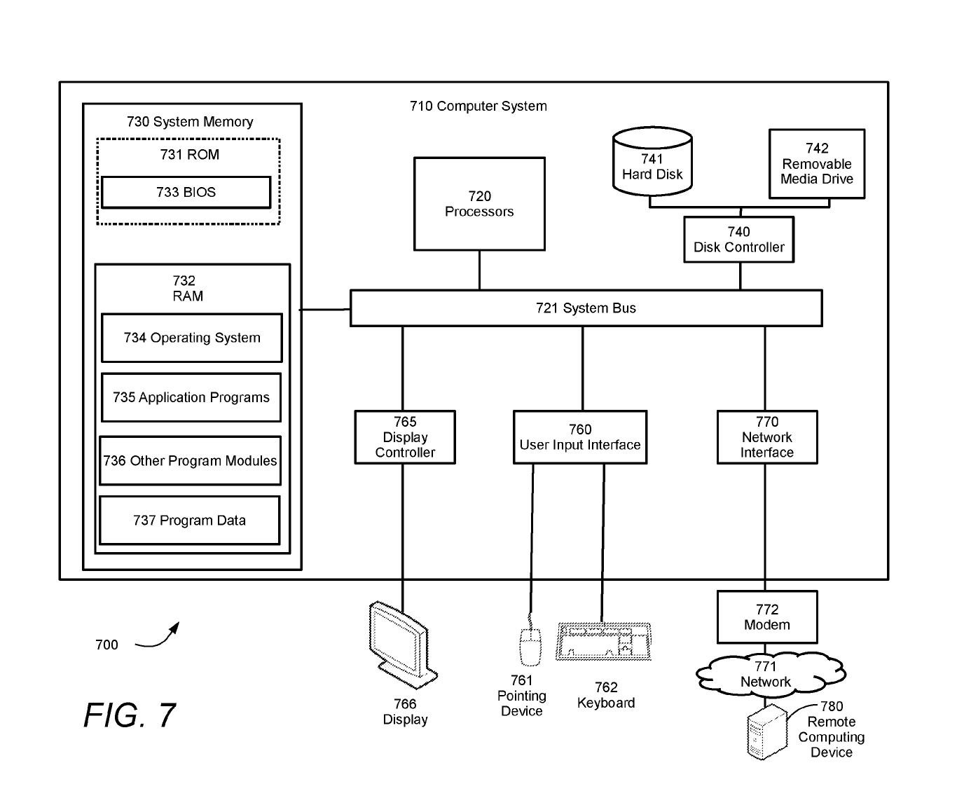

Physically, EML 230 is deployed inside a factory plant, with access to the MES layer 221. The EML 230 may be implemented in a computer system, such as the computer system described below with reference to FIG. 7. EML 230 includes software and processor instructions that when executed by the EML processor produces a special purpose machine for the integrated optimization of production and energy. EML 230 also communicates with utility-side demand management systems, such as RTPS 213. EML 230 may communicate with the RTPS 213 via Internet protocols, such as OpenADR. EML 230 acts to incorporate factories into the Smart Grid, optimizing production schedules according to the Smart Grid conditions.

EML 230 resides in between the traditional automation pyramid 221, 223, 225 and the smart grid 210.

FIG. 2b is a block diagram of the EML shown in FIG. 2a showing the EML 230 in greater detail. The EML 230 is in communication with the RTPS 213 via a distributed network, such as the Internet 240. The EML 230 includes a user interface 250 allowing a user to control the functions of the EML 230. The user interface may be implemented on a connected computer for example, through a web browser. The web browser connects to and communicates with a web server 234. Web server 234 may include software configured to receive inputs from the user interface 250, process the information and perform various functions of the EML 230. The EML further includes components to enable communication with the Manufacturing domain 220. Data logger 236 tracks information on various states of the Factory and provides the state information to the processors of the EML 230. Modbus interface 237 provides a serial communications protocol link between the EML 230 and PLCs 223. OLE Process Control (OPC) interface 238 provides object linking and embedding (OLE) process control to drive various control components of the MES 221. The control components of the MES 221 communicate with the PLC 223 to control field devices 225 via actuators configured to implement various operating parameters of the field devices 225.

EML 230 includes an optimization engine 233 for determining optimal parameters for operating the factory. Optimization engine 233 receives information relating to the factory and information relating to the smart grid and considers both domains to determine optimal times for operating machines in the factory to meet production goals. For example, optimization engine receives information about the smart grid, for example tariff model 235 and other information such as the time-based energy prices provided by the utility for a future timeframe. For example, a utility may provide hourly energy prices for the following day posting this information publicly at the end of the prior day.

EML 230 includes a runtime manager 231 and a data repository 232. Data repository 232 stores information relating to the smart grid domain as well as information relating to the manufacturing domain 220, including information generated by data logger 236. Runtime manager 231 manages control signals and/or variables containing information for providing a control scheme for MES 221.

There are two common methods to present processes graphically. A process can be represented as a State-Task Network (STN) or as a Resource-Task Network (RTN).

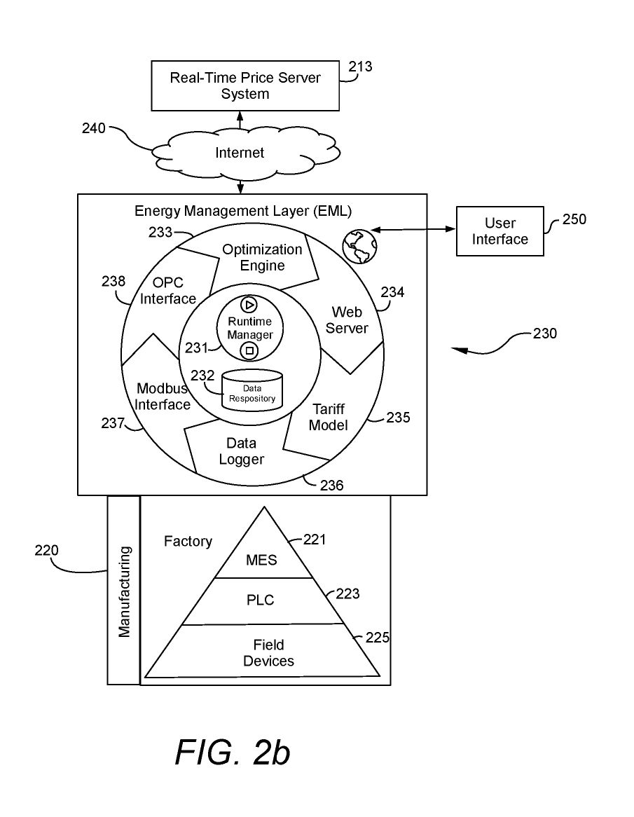

FIG. 3 is an example of a process 300 denoted as an STN. In STN, state nodes are denoted by circles, representing raw materials, intermediate materials or final products. The task nodes are denoted by a rectangular box, representing the manufacturing process. The sequence is captured by the directed graph. Referring to FIG. 3, state 1 (51, 301) represents a first material. 51 301 is acted on in block denoted Task 1 303. Task 1 303 transforms material 51 301 to a second material S2 305. Second material S2 305 is acted on by Task 2 307 and Task 3 309. From Task 2 307, second material (or product) S2 305 is transformed to material or product S3 311. Meanwhile, Task 3 309 transforms material S2 305 to material S5 313 and to material S6 315. As denoted on the STN graph of FIG. 3, 90% of the output of Task 3 309 is transformed to material S5 313, while 10% of the output of Task 3 309 is transformed to material S6 315. Referring again to material S3 311, material S3 311 is provided to Task 4 along with a portion of material S5 313. Task 4 processes its inputs S3 311 and S5 313 to produce material or product S4 319 and material S2 305 at percentages of 60% and 40%, respectively. Material S5 313 is provided to Task 5 321 which transforms material S5 313 to product S7 323.

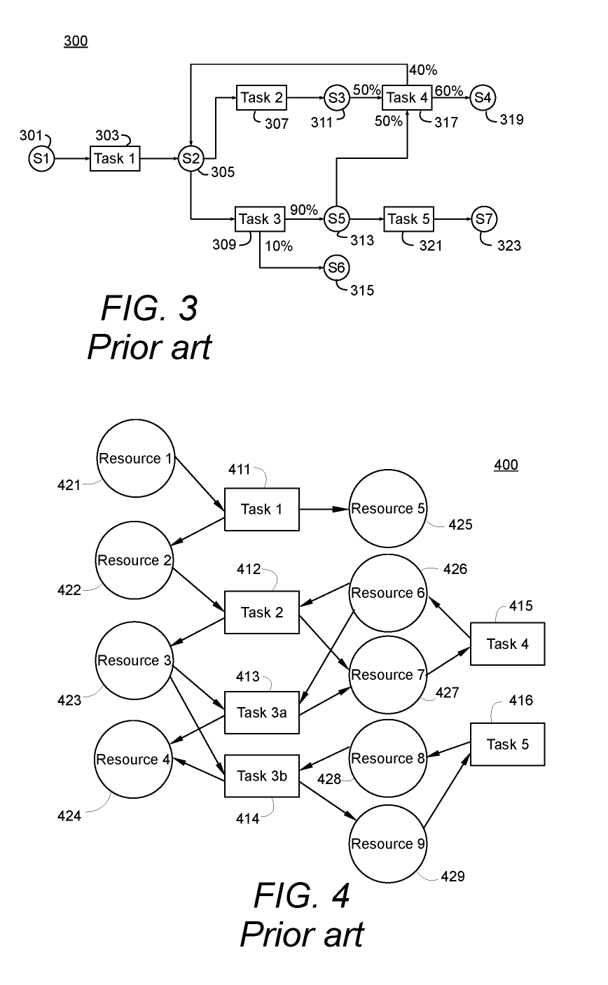

FIG. 4 is a block diagram of a Resource-Task Network (RTN). The RTN is an extension of the STN and characterizes a uniform description of available resources, such as materials, processing equipment, storage and utilities. RTN is a method to capture the resource demands for individual tasks. A resource circle in the graph can be either material or a machine. Each task transforms a set of resources to another set of resources. Referring now to FIG. 4, materials, other resources and their interactions with tasks are included in the network. Resource 1 421, resource 2 422, resource 3 423 and resource 4 424 represent materials that the tasks 411, 412, 413, 414 consume. Meanwhile, resource 5 425, resource 6 426, resource 7 427, resource 8 429 and resource 9 429 represent equipment which may be viewed as being consumed when indicated as the start of a task and produced at the end of a task as indicated by the point of the interaction arrow. It should be noted that certain properties of a particular machine or piece of equipment may be altered by a task (e.g. the machine may have become dirty during the performance of the task) and may require an additional task, such as cleaning to restore the machine prior to being used again for the first task. In such a scenario, the machine is viewed as two resources, one before the task and one after the task. For example in FIG. 4, Task 2 412 uses Resource 6 426 and produces Resource 7 427. Resource 7 427 is the machine of Resource 6 416 in a soiled state. Resource 7 427 is restored to a clean state (Resource 6 426) by Task 4 415, which is representative of a cleaning operation. Resource 8 428 and Resource 9 429 provide another example of a similar relationship via Task 5 416. Also, tasks that take place in different machines or units are regarded as different tasks. For example, Task 3a 413 and Task 3b 414 consume the same Resource 3 423 and produce the same product Resource 4 424. However, Task 3a 413 uses Resource 6 426, while Task 3b 414 uses Resource 8 428.

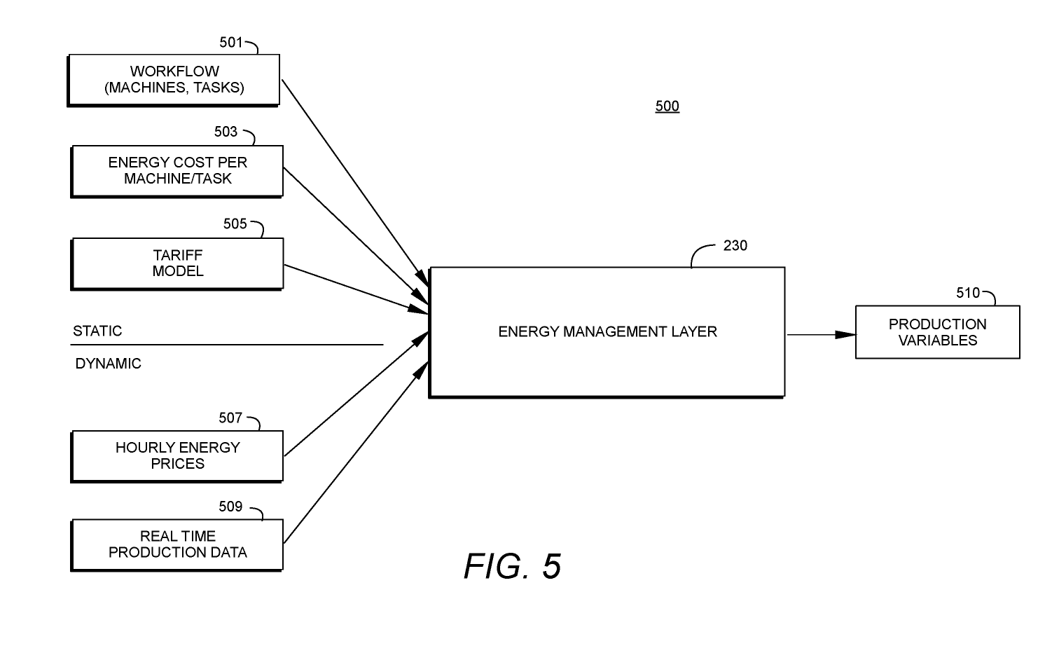

FIG. 5 is a block diagram 500 of the operation of an Energy Management Layer (EML) placed between the smart grid domain and the manufacturing domain as depicted in FIG. 2 according to embodiments of this disclosure. The EML 230 may include a software component, a hardware component or a combination of hardware and software. The EML may be considered to be a special purpose machine which provides a connection between the manufacturing domain and the smart grid domain. The EML 230 is in communication with both the smart grid domain, for example through RTPS with respect to the smart grid domain, and the Manufacturing control systems such as MES with respect to the manufacturing domain. Since the EML 330 is in communication with both the manufacturing domain and the smart grid domain, the EML may be configured to optimize manufacturing operations not only from a production level or efficiency perspective, but also optimize operations based on energy cost information related to the smart grid. For example, in some cases, a utility may update energy prices on an hourly basis based on supply from the resource generating electrical power in the smart grid and the demand placed on the smart grid through various resources consuming energy from the grid.

EML 230 receives static variables relating to the manufacturing domain. For example EML 230 may receive at least the factory workflow 501, the amount of energy cost per machine and/or task 503 and tariff model 505. The factory workflow 501 may be characterized by information such as the information provided in a source task network similar to the STN shown above in FIG. 4. In addition, the cost incurred for operation of each machine, or alternatively the cost for performing a given task. A tariff model 505 relating to charges levied by the utility is also provided to EML 230.

EML 230 also receives dynamic information in the form of hourly energy prices 507 and real-time production data 509 by way of example. While the embodiment of FIG. 5 describes an hourly energy price list, other time windows may be provided by a utility. For example, prices corresponding to morning, afternoon or evening hours may be provided. These different time windows also fall within the intended scope of this disclosure. The hourly energy prices may be provided by a utility by posting the hourly energy prices publicly for a near future time period (e.g. the next day).

EML 230 processes the input values and performs an optimization which optimizes not only the factory production schedule, but also considers the most economical times to perform various production tasks based on the varying energy prices throughout the day. As will be described in greater detail herein below, EML 230 performs calculations to calculate production variables 510. The production variables 510 may be provided to the runtime manager for communication to the MES in the manufacturing domain. The variables are used to produce control signals provided to the PLCs producing activation signals to actuators associated with the field devices. The result is a production schedule in which required tasks are performed by one or more machines, each machine being put into service at time windows when the energy costs are minimized while still achieving production constraints.

In the following paragraphs, the translation of an STN graph into a matrix representation that is acceptable to mixed integer linear programming (MILP) solvers will be presented.

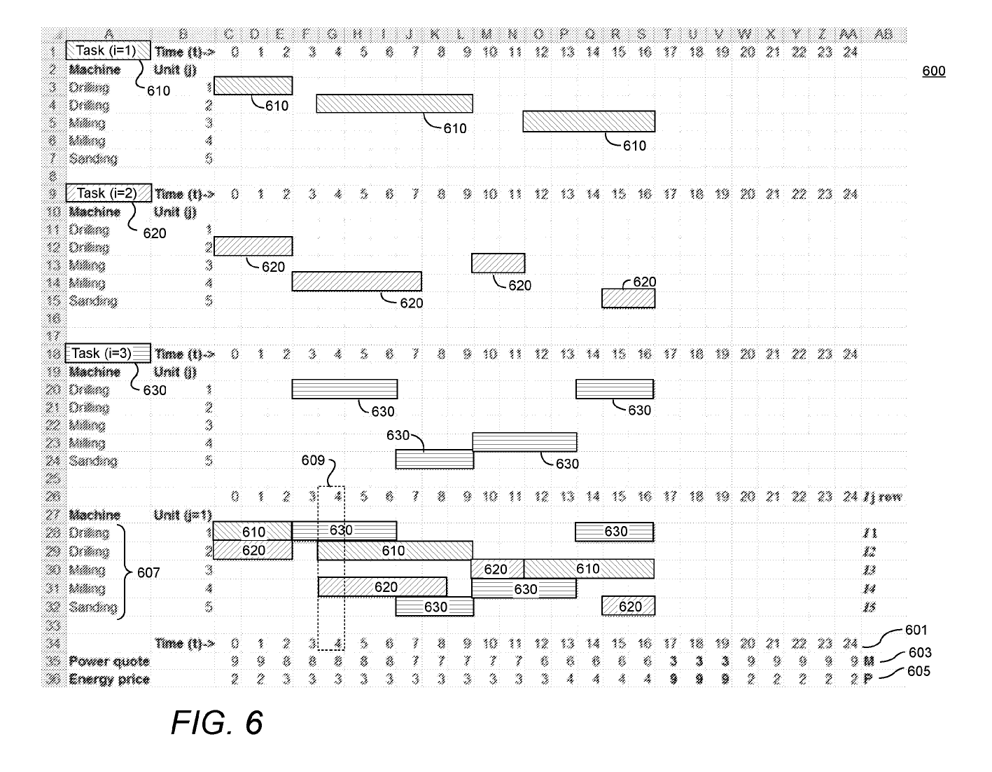

With reference to FIG. 6, a simple discrete manufacturing schedule optimization problem 600 including the calculated results for producing an optimized production schedule based on energy prices is shown. There are three parts or tasks 610, 620, 630, assigned to five machines 607. As seen in FIG. 6, a single task may be spread across multiple machines. Additionally, there may be more than one machine of a specific type. In the example of FIG. 6, there are two drilling machines, two milling machines, and one sanding machine. The embodiment of FIG. 6 is provided by way of example only and a person of ordinary skill in the art will recognize that another number of tasks and/or a different configuration of machines may be used without departing from the scope of this disclosure. The energy costs 505 and power quote 503 (max kW at each time slot) are listed at the bottom of FIG. 6. The time (by hour) for a 24-hour period is indicated horizontally across FIG. 6 associated with each of Task i=1 510, Task i=2 520 and Task i=3 530 and at the bottom of FIG. 6 501. The objective is to schedule the tasks 510, 520, 530 for minimal energy cost, yet meet the power quote constraint. The calculation of the production variables based on an optimized production schedule will now be described.

A scheduling parameter may be defined as:

$${W}_{ijt} ∈ \{ 0 , 1 \}$$

$${\sum }_{i ∈ {I}_{j}} {W}_{ijt} \leq 1 , ∀ j ∈ J , t ∈ T ,$$

Where Iⱼ is the set of tasks that can be performed in unit (j); Wᵢⱼₜ is a set of binary values. The binary value one (1) means that task (i) starts at unit (j) at the beginning of time interval (t). The constraint of less or equal to 1 means that at most one task can start at the beginning of each time interval, for a specific unit. In other words, a machine cannot process two parts at the same time.

A visual interpretation of Σ_{i∈I}_{ⱼ} Wᵢⱼₜ is shown in FIG. 6. Each task 610, 620, 630 is associated with the task of manufacturing one type of part. The units include the following machines: drilling, milling, and sanding. There may be multiple machines for one type. E.g., there are two drilling machines and two milling machines. Many tasks require a certain sequence.

In order to regulate the whole factory peak load and energy bill, a discrete load quote, Qₜ, and energy price, Pₜ need to be introduced. The labeled power, that is, hourly energy consumption, for unit (j) is denoted as Cⱼ. The quote Qₜ is assigned by utilities, which is constrained as:

$${\sum }_{i ∈ {I}_{j}} {C}_{j} {W}_{ijt} \leq {Q}_{t} , ∀ j ∈ J , t ∈ T .$$

The total energy bill, C is defined as:

$$C = {\sum }_{i ∈ T} {\sum }_{i ∈ {I}_{j}} {C}_{j} {W}_{ijt}$$

The productivity can be measured by the utility ratio R, which is defined as:

$$R = \frac{{\sum }_{t ∈ T} {\sum }_{j ∈ N} {\sum }_{i ∈ {I}_{j}} {W}_{ijt}}{{\sum }_{t ∈ T} {\sum }_{i ∈ T} {\sum }_{i ∈ {I}_{j}} 1} .$$

R is a value between 0 and 1, with “1” meaning 100% utilization of the units (i.e., machines). The objective of the optimization is denoted J, which represents a tradeoff between C and R. That is, the tradeoff may be characterized as the desire to operate at high capacity or efficiency (R), while controlling costs by operating at times that are economically favorable based on the total energy bill (C). The tradeoff exists because the cost of running the factory at full capacity may be greater than benefit derived from the resulting product, due to the energy costs incurred to achieve full production. The optimization may determine that it is better to reduce production and shut down certain machines at times when energy costs are at their greatest. For example, with reference to FIG. 6, at the times between 17:00 and 24:00 hours, it is determined that it is not economically practical to operate any of the units due to the high power quote 503 and energy prices 505 associated with those time slots.

As may be seen in FIG. 6, task 510 requires a drilling operation followed by a milling operation. The optimization has determined that the first drilling unit (1) will operate between 00:00 and 02:00, beginning the drilling operation. The drilling operation is completed by the second drilling unit (2) between 04:00 and 09:00. Finally, the milling operation is performed by unit 4 between 12:00 and 16:00. Task 2 520 and Task 3 530 are scheduled in a similar manner. At the bottom of the figure, the three tasks 510, 520, 530 are superimposed on one another. As may be seen, within the perspective of the production process, multiple units may be operating on different tasks during a given time period. For example, at time 04:00 (509), Task 3 530 is being performed by first drilling machine unit 1, Task 1 510 is being performed by second drilling machine unit 2, and Task 2 520 is performed by second milling unit 4.

As stated above, the objective of the optimization is minimizing J, which is a tradeoff between C and R.

min J=αC+(1−α)(1−R),α∈[0,1].

Subject to:

$${\sum }_{i ∈ {I}_{j}} {W}_{ijt} \leq 1 , ∀ j ∈ J , t ∈ T , \\ {W}_{ijt} ∈ \{ 0 , 1 \} , \\ {\sum }_{i ∈ {I}_{j}} {C}_{j} {W}_{ijt} \leq {Q}_{t} , ∀ j ∈ J , t ∈ T .$$

This problem may be solved by Mix Integer Programming tools to produce a set of output production variables.

FIG. 7 illustrates an exemplary computing environment 700 within which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more data stores and data files used by embodiments of the present invention. Data store contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

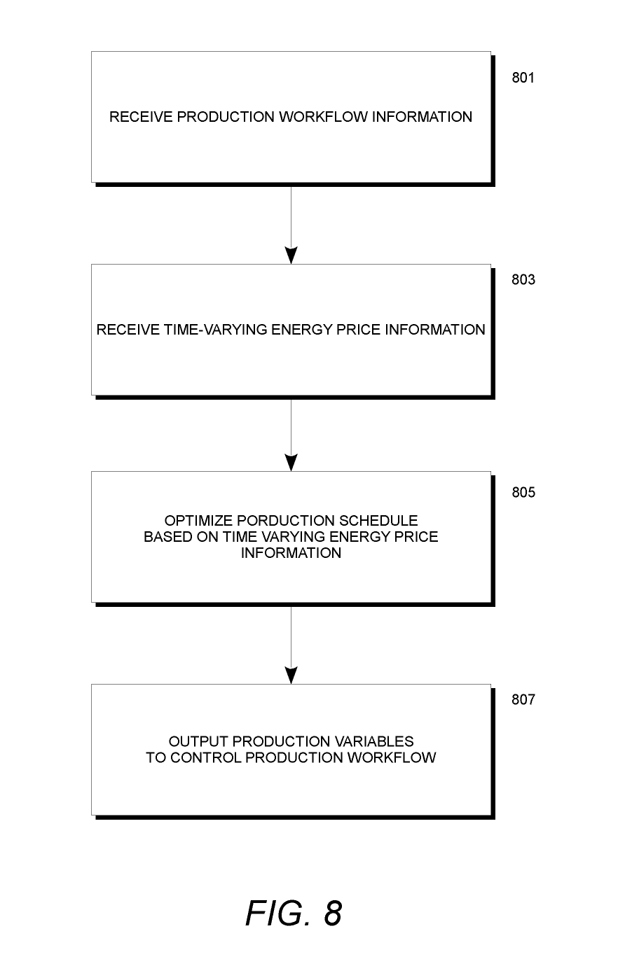

Referring now to FIG. 8, a process flow diagram for a method of optimizing a factory production schedule based at least in part on time varying energy price information is provided. Information relating to the production workflow for a factory is received 801. The information may include workflow information. The workflow information may be provided, by way of example, in a STN. Additionally, cost information relating to the costs to operate one or more production units is received along with information relating to tariff models or incentives offered by a utility. Time varying energy price information is received 803. Time varying energy price information may include a periodic schedule of energy prices for a near future timeframe. For example, an hourly schedule of energy prices corresponding to a day following the day on which the time varying energy price information is retrieved may be received.

The information relating to the production workflow and the information relating to the time varying energy price information is used to optimize a production schedule based at least in part on the time varying energy price information 805. A special purpose processor may be used to perform the optimization, which converts a workflow representation, such as a state-task network, and converts the information into mathematical representations that serve as acceptable inputs to the mixed integer linear programming algorithm. The MILP algorithm is performed to generate output production variables to control the production workflow 807 and schedule production actions in time slots which provide the greatest energy savings while meeting energy quote constraints.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A method of integrating manufacturing processing and energy delivery costs optimization in a factory comprising the steps of:
establishing an energy management layer in communication with an energy domain containing a smart grid and a manufacturing domain containing a manufacturing execution system, the energy management layer comprising:
a data logger for capturing state information of the factory;
an interface between the energy management layer and a controller in the factory;
a web server for receiving information relating to the energy delivery costs;
a data store for storing the state information and the energy delivery costs; and
an optimization engine in communication with the data store to perform calculations on integrated factory state data and energy delivery cost data;
receiving information relating to the operation of production units to the energy management layer via the interface in the data store;
receiving information relating to time varying energy prices via the web server in the data store;
optimizing in the optimization engine within the energy management layer, a production schedule for performance of at least one task by at least one production unit within a time window that is optimized based at least in part on the information relating to the time varying energy prices.

2. The method of claim 1, wherein providing information relating to the operation of production units comprises:
providing information relating to a workflow of the factory;
providing information relating to a cost of operation of the at least one production unit;
providing information relating to at least one of a tariff model and energy cost incentives provided by a utility.

3. The method of claim 2, wherein providing information relating to time varying prices of energy comprises:
obtaining a periodic schedule of energy prices from a utility, wherein the periodic schedule of energy prices reflects a unit cost of energy for a pre-determined time period within a near future timeframe.

4. The method of claim 3, wherein obtaining a periodic schedule of energy prices comprises:
accessing a public data store of the utility; and
retrieving from the data store a schedule of prices providing a unit energy price for a given hour in a day following the day on which the schedule of prices was retrieved.

5. The method of claim 2, wherein the workflow of the factory is provided as a State-Task Network (STN).

6. The method of claim 2, wherein the workflow of the factory is provided as a Resource-Task Network (RTN).

7. The method of claim 2, wherein providing information to a cost of operation of the at least one production unit comprises:
providing an energy cost incurred by activating a production unit to perform a given task.

8. The method of claim 1, wherein providing information relating to time varying prices of energy comprises:
obtaining a periodic schedule of energy prices from a utility, wherein the periodic schedule of energy prices reflects a unit cost of energy for a pre-determined time period within a near future timeframe.

9. The method of claim 8, wherein obtaining a periodic schedule of energy prices comprises:
accessing a public data store of the utility; and
retrieving from the data store a schedule of prices providing a unit energy price for a given hour in a day following the day on which the schedule of prices was retrieved.

10. The method of claim 1, wherein the energy management layer is in communication with the energy domain via a distributed network.

11. The method of claim 10, wherein the distributed network is the Internet.

12. The method of claim 1 wherein optimizing a production schedule for performance of the at least one task by at least one production unit comprises:
determining a power quote for each time slot of a plurality of time slots within a given timeframe;
determining an energy cost for each of the time slots in the plurality of time slots;
scheduling the at least one task in time slots in which the determined energy cost is minimized while meeting a power quote constraint for the scheduled time slots.

13. The method of claim 1, further comprising the steps of:
defining a scheduling parameter according to:
$${W}_{ijt} ∈ \{ 0 , 1 \} , \\ {\sum }_{i ∈ {I}_{j}} {W}_{ijt} \leq 1 , ∀ j ∈ J , t ∈ T ,$$
where Iⱼ is a set of tasks that may be performed in unit j; and
Wᵢⱼₜ is a set of binary values wherein a value of 1 represents that a task I starts at unit j at a beginning of a time interval t.

14. The method of claim 13, further comprising the step of:
defining a total energy bill C, according to:
$$C = {\sum }_{i ∈ T} {\sum }_{i ∈ {I}_{j}} {C}_{j} {W}_{ijt} .$$

15. The method of claim 14, further comprising the step of:
defining a utility ratio representative of the factory's productivity according to:
$$R = \frac{{\sum }_{t ∈ T} {\sum }_{j ∈ N} {\sum }_{i ∈ {I}_{j}} {W}_{ijt}}{{\sum }_{t ∈ T} {\sum }_{i ∈ T} {\sum }_{i ∈ {I}_{j}} 1} .$$

16. The method of claim 15, wherein R is a value between zero and one, a value of one representing 100% utilization on all units J.

17. The method of claim 13, wherein the optimizing step further comprises:
optimizing the value of J, according to:
min J=αC+(1−α)(1−R),α∈[0,1].

18. The method of claim 17, wherein optimizing the value of J is subject to:
$${\sum }_{i ∈ {I}_{j}} {W}_{ijt} \leq 1 , ∀ j ∈ J , t ∈ T , \\ {W}_{ijt} ∈ \{ 0 , 1 \} , \\ {\sum }_{i ∈ {I}_{j}} {C}_{j} {W}_{ijt} \leq {Q}_{t} , ∀ j ∈ J , t ∈ T .$$
